(19) United States
(12) Patent Application Publication
(10) Pub. No.: US 2011/0011805 A1
(43) Pub. Date: Jan. 20, 2011

(54) POROUS METAL ORGANIC FRAMEWORKS AS DESICCANTS

(75) Inventors: Markus Schubert, Ludwigshafen (DE); Ulrich Mueller, Neustadt (DE); Christoph Kiener, Weisenheim am Sand (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/863,339

(22) PCT Filed: Jan. 23, 2009
(86) PCT No.: PCT/EP09/50747

§ 371 Date: Jul. 16, 2010

(30) Foreign Application Priority Data
Jan. 24, 2008 (EP) 08150593.5

(51) Int. Cl. B01D 15/08

(52) U.S. Cl. 210/689

(57) ABSTRACT

The present invention relates to the use of a porous metal organic framework comprising at least one at least bidentate organic compound coordinate to at least one metal ion as desiccant for reducing the water content of an organic liquid or for removing water from an organic liquid.

The present invention relates to the use of porous metal organic frameworks as desiccants.

Chemical reactions are frequently carried out using solvents which function as reaction medium. These are typically organic liquids which comprise an organic solvent or a mixture of such solvents.

In such chemical reactions, problems can be caused by traces of water which reduce the yield of a reaction or completely prevent such a reaction from taking place. Numerous methods have therefore been developed for reducing the water content of organic liquids.

One simple possibility is to bring the solvent into contact with a desiccant so that the water present in the solvent is bound to the desiccant and the proportion of water in the organic solvent is correspondingly reduced.

Known desiccants of this type are molecular sieves, calcium chloride, magnesium sulfate and the like.

Despite the desiccants known in the prior art, there is a need for alternative desiccants which are particularly efficient at drying organic liquids.

It is therefore an object of the present invention to provide new materials for such a use.

The object is achieved by the use of a porous metal organic framework comprising at least one at least bidentate organic compound coordinate to at least one metal ion as desiccant for reducing the water content of an organic liquid or for removing water from an organic liquid.

It has been found that metal organic frameworks are not only able to act as adsorbents, in particular for gases or for gas separation, but are also highly suitable for drying organic liquids.

Porous metal organic frameworks are therefore able to be used as desiccants for reducing the water content of an organic liquid or for removing water from an organic liquid.

Such metal organic frameworks (MOFs) are known in the prior art and are described, for example, in U.S. Pat. No. 5,648,508, EP-A-0 790 253, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, and DE-A-101 11 230.

A specific group of these metal organic frameworks described in the recent literature are “limited” frameworks in which, due to specific choice of the organic compound, the skeleton does not extend infinitely but forms polyhedra. A. C. Sudik, et al., J. Am. Chem. Soc. 127 (2005), 7110-7118, describes such specific frameworks. Here, these are referred to as metal organic polyhedra (MOP) to differentiate them.

A further specific group of porous metal organic frameworks are those in which the organic compound used as ligand is a monocyclic, bicyclic or polycyclic ring system which is derived from at least one heterocycle selected from the group consisting of pyrrole, alpha-pyridone and gamma-pyridone and has at least two ring nitrogens. The electrochemical preparation of such frameworks is described in WO-A 2007/131955.

These specific groups are particularly suitable for the purposes of the present invention.

The metal organic frameworks used according to the present invention comprise pores, in particular micropores and/or mesopores. Micropores are defined as pores having a diameter of 2 nm or less and mesopores are defined by a diameter in the range from 2 to 50 nm, in each case in accordance with the definition given in Pure & Applied Chem. 57 (1983), 603-619, in particular on page 606. The presence of micropores and/or mesopores can be checked by means of sorption measurements, with these measurements determining the uptake capacity of the MOFs for nitrogen at 77 kelvin in accordance with DIN 66131 and/or DIN 66134.

The specific surface area, calculated according to the Langmuir model (DIN 66131, 66134), of a metal organic framework in powder form is preferably more than 100 m²/g, more preferably above 300 m²/g, more preferably more than 700 m²/g, even more preferably more than 800 m²/g, even more preferably more than 1000 m²/g and particularly preferably more than 1200 m²/g.

Shaped MOF bodies can have a lower active surface area, but preferably more than 150 m²/g, more preferably more than 300 m²/g, even more preferably more than 700 m²/g.

The metal component in the framework according to the present invention is preferably selected from groups Ia, IIa, IIIa, IVa to VIIIa and Ib to VIb. Particular preference is given to Mg, Ca, Sr, Ba, Sc, Y, Ln, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Tl, Si, Ge, Sn, Pb, As, Sb and Bi, where Ln represents lanthanides.

Lanthanides are La, Ce, Pr, Nd, Pm, Sm, En, Gd, Tb, Dy, Ho, Er, Tm, Yb.

As regards the ions of these elements, particular mention may be made of Mg²⁺, Ca²⁺, Sr²⁺, Ba²⁺, Sc³⁺, Y³⁺, Ln³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh+, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺ and Bi⁺.

More particular preference is given to Zn, Al, Mg, Cu, Mn, Fe, Co, Ni, Ti, Zr, Y, Sc, V, In, Ca, Cr, Mo, W, Ln. Greater preference is given to Al, Cu, Zr, Y, Ln, Mn and Mg. Very particular preference is given to Cu.

The term “at least bidentate organic compound” refers to an organic compound which comprises at least one functional group which is able to form at least two coordinate bonds to a given metal ion and/or form a coordinate bond to each of two or more, preferably two, metal atoms.

As functional groups via which the abovementioned coordinate bonds can be formed, mention may be made by way of example of, in particular: —CO₂H, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(RSH)₂, —C(RSH)₃—CH(RNH₂)₂ —C(RNH₂)₃, —CH(ROH)₂, —C(ROH)₃, —CH(RCN)₂, —C(RCN)₃, where R is preferably, for example, an alkylene group having 1, 2, 3, 4 or 5 carbon atoms, for example a methylene, ethylene, n-propylene, i-propylene, n-butylene, i-butylene, tert-butylene or n-pentylene group, or an aryl group comprising 1 or 2 aromatic rings, for example 2 C₆ rings, which may, if appropriate, be fused and may, independently of one another, be appropriately substituted by in each case at least one substituent and/or may, independently of one another, comprise in each case at least one heteroatom, for example N, O and/or S. In likewise preferred embodiments, mention may be made of functional groups in which the abovementioned radical R is not present. In this regard, mention may be made of, inter alia, —CH(SH)₂, —C(SH)₃, —CH(NH₂)₂, —C(NH₂)₃, —CH(OH)₂, —C(OH)₃, —CH(CN)₂ or —C(CN)₃.

However, the functional groups can also be heteroatoms of a heterocycle. Particular mention may here be made of nitrogen atoms.

The at least two functional groups can in principle be bound to any suitable organic compound as long as it is ensured that the organic compound comprising these functional groups is capable of forming the coordinate bond and of producing the framework.

The organic compounds which comprise at least two functional groups are preferably derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound more preferably comprises from 1 to 15, more preferably from 1 to 14, more preferably from 1 to 13, more preferably from 1 to 12, more preferably from 1 to 11 and particularly preferably from 1 to 10, carbon atoms, for example 1, 2, 3, 4, 5, 6, 7, 8, 9 or 10 carbon atoms. Particular preference is here given to, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings being able to be present in fused form. The aromatic compound or the aromatic part of the both aliphatic and aromatic compound particularly preferably has one, two or three rings, with particular preference being given to one or two rings. Furthermore, the rings of said compound can each comprise, independently of one another, at least one heteroatom such as N, O, S, B, P, Si, Al, preferably N, O and/or S. More preferably, the aromatic compound or the aromatic part of the both aromatic and aliphatic compound comprises one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound is more preferably an aliphatic or aromatic, acyclic or cyclic hydrocarbon which has from 1 to 18, preferably from 1 to 10 and in particular 6, carbon atoms and in addition has exclusively 2, 3 or 4 carboxyl groups as functional groups.

For example, the at least bidentate organic compound is derived from a dicarboxylic acid such as oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl)ether)diimidedicarboxylic acid, 4,4′-diaminodiphenylmethanediimidedicarboxylic acid, (bis(4-aminophenyl) sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid.

The at least bidentate organic compound is even more preferably one of the dicarboxylic acids mentioned above by way of example as such.

For example, the at least bidentate organic compound can be derived from a tricarboxylic acid such as

2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

The at least bidentate organic compound is even more preferably derived from one of the tricarboxylic acids mentioned above by way of example as such.

Examples of an at least bidentate organic compound derived from a tetracarboxylic acid are

1,1-dioxidoperylo[1,12-BCD]thiophene-3,4,9,10-tetracarboxylic acid, perylenetetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

The at least bidentate organic compound is even more preferably one of the tetracarboxylic acids mentioned above by way of example as such.

In a preferred embodiment, the at least one at least bidentate organic compound is thus derived from a dicarboxylic, tricarboxylic or tetracarboxylic acid or is such an acid.

For the purposes of the present invention, the term “derived” means that the dicarboxylic, tricarboxylic or tetracarboxylic acid can be present in partially deprotonated or fully deprotonated form in the framework. Furthermore, the dicarboxylic, tricarboxylic or tetracarboxylic acid can comprise a substituent or, independently of one another, a plurality of substituents. Examples of such substituents are —OH, —NH₂, —OCH₃, —CH₃, —NH(CH₃), —N(CH₃)₂, —CN and halides. Furthermore, the term “derived” means, for the purposes of the present invention, that the dicarboxylic, tricarboxylic or tetracarboxylic acid can also be present in the form of the corresponding sulfur analogues. Sulfur analogues are the functional groups —C(═O)SH and its tautomer and C(═S)SH, which can be used instead of one or more carboxylic acid groups. Furthermore, the term “derived” means, for the purposes of the present invention, that one or more carboxylic acid fractions can be replaced by a sulfonic acid group (—SO₃H). Furthermore, it is likewise possible for a sulfonic acid group to be present in addition to the 2, 3 or 4 carboxylic acid functions.

Preferred heterocycles as at least bidentate organic compounds, in the case of which a coordinate bond is formed via the ring heteroatoms, are the following substituted or unsubstituted ring systems:

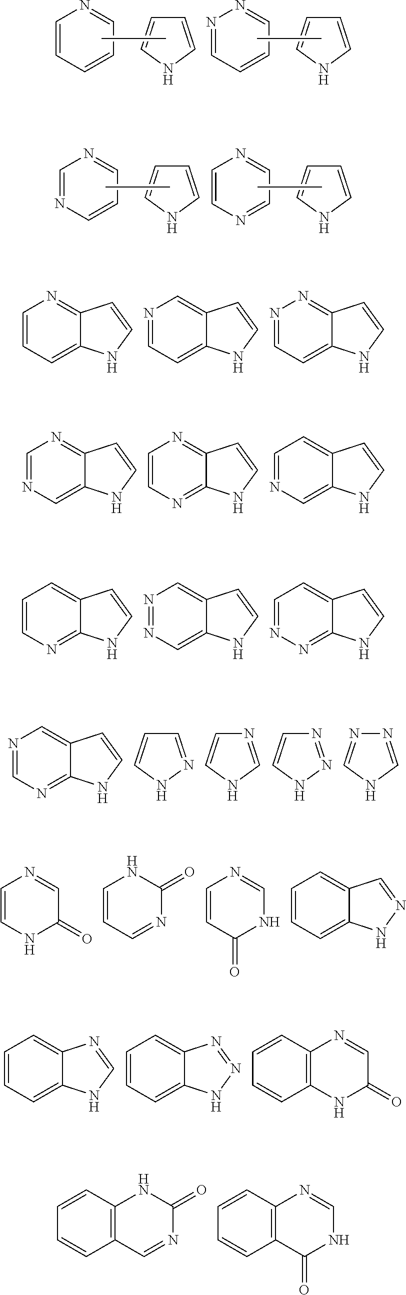

Very particular preference is given to using optionally at least monosubstituted aromatic dicarboxylic, tricarboxylic or tetracarboxylic acids which have one, two, three, four or more rings and in which each of the rings can comprise at least one heteroatom, with two or more rings being able to comprise identical or different heteroatoms. For example, preference is given to one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, P and preferred heteroatoms here are N, S and/or O, Suitable substituents which may be mentioned in this respect are, inter alia, —OH, a nitro group, an amino group or an alkyl or alkoxy group.

Particular preference is given to using imidazolates such as 2-methylimidazolate, acetylenedicarboxylic acid (ADC), camphordicarboxylic acid, fumaric acid, succinic acid, benzenedicarboxylic acids such as phthalic acid, isophthalic acid, terephthalic acid (BDC), aminoterephthalic acid, triethylenediamine (TEDA), naphthalenedicarboxylic acids (NDC), biphenyldicarboxylic acids such as 4,4′-biphenyldicarboxylic acid (BPDC), pyrazinedicarboxylic acids such as 2,5-pyrazinedicarboxylic acid, bipyridinedicarboxylic acids such as 2,2′-bipyridinedicarboxylic acids such as 2,2′-bipyridine-5,5′-dicarboxylic acid, benzenetricarboxylic acids such as 1,2,3-, 1,2,4-benzenetricarboxylic acid or 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate or dihydroxyterephthalic acids such as 2,5-dihydroxyterephthalic acid (DHBDC) as at least bidentate organic compounds.

Very particular preference is given to, inter alia, 2-methylimidazole, 2-ethylimidazole, phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid, 1,2,4,5-benzenetetracarboxylic acid, aminoBDC, TEDA, fumaric acid, biphenyldicarboxylate, 1,5- and 2,6-naphthalenedicarboxylic acid, tert-butylisophthalic acid, dihydroxybenzoic acid.

In particular, preference is given to terephthalic acid, 2,6- and 1,5-naphthalenedicarboxylic acid, isophthalic acid, fumaric acid, 1,3,5-benzenetricarboxylic acid (BTC), trimellitic acid, glutaric acid, 2,5-dihydroxyterephthalic acid and 4,5-imidazoledicarboxylic acid and also acids derived therefrom. Very particular preference is given to BTC.

In addition to these at least bidentate organic compounds, the metal organic framework can further comprise one or more monodentate ligands and/or one or more at least bidentate ligands which are not derived from a dicarboxylic, tricarboxylic or tetracarboxylic acid.

In addition to these at least bidentate organic compounds, the MOF can further comprise one or more monodentate ligands.

Suitable solvents for preparing the MOFs are, inter alia, ethanol, dimethylformamide, toluene, methanol, chlorobenzene, diethylformamide, dimethyl sulfoxide, water, hydrogen peroxide, methylamine, sodium hydroxide solution, N-methylpyrrolidone, ether, acetonitrile, benzyl chloride, triethylamine, ethylene glycol and mixtures thereof. Further metal ions, at least bidentate organic compounds and solvents for the preparation of MOFs are described, inter alia, in U.S. Pat. No. 5,648,508 or DE-A 101 11 230.

The pore size of the metal organic framework can be controlled by selection of the appropriate ligand and/or the at least bidentate organic compound. It is frequently the case that the larger the organic compound, the larger the pore size. The pore size is preferably from 0.2 nm to 30 nm, particularly preferably in the range from 0.3 nm to 3 nm, based on the crystalline material.

However, larger pores whose size distribution can vary also occur in a shaped MOF body. However, preference is given to more than 50% of the total pore volume, in particular more than 75%, being made up by pores having a pore diameter of up to 1000 nm. However, a large part of the pore volume is preferably made up by pores having two different diameter ranges. It is therefore more preferred for more than 25% of the total pore volume, in particular more than 50% of the total pore volume, to be made up by pores which are in a diameter range from 100 nm to 800 nm and for more than 15% of the total pore volume, in particular more than 25% of the total pore volume, to be made up by pores which are in a diameter range up to 10 nm. The pore distribution can be determined by means of mercury porosimetry.

Examples of metal organic frameworks are given below. In addition to the designation of the MOF, the metal and the at least bidentate ligand, the solvent and the cell parameters (angles α, β and γ and the dimensions A, B and C in Å) are indicated. The latter were determined by X-ray diffraction.

| | Constituents | | | | | | | | |
|---|---|---|---|---|---|---|---|---|---|
| | molar ratio | | | | | | | | Space |
| MOF-n | M + L | Solvents | α | β | γ | a | b | c | group |
| MOF-0 | Zn(NO₃)₂•6H₂O | ethanol | 90 | 90 | 120 | 16.711 | 16.711 | 14.189 | P6(3)/ |
| | H₃(BTC) | | | | | | | | Mcm |
| MOF-2 | Zn(NO₃)₂•6H₂O | DMF | 90 | 102.8 | 90 | 6.718 | 15.49 | 12.43 | P2(1)/n |
| | (0.246 mmol) | toluene | | | | | | | |
| | H₂(BDC) | | | | | | | | |
| | 0.241 mmol) | | | | | | | | |
| MOF-3 | Zn(NO₃)₂•6H₂O | DMF | 99.72 | 111.11 | 108.4 | 9.726 | 9.911 | 10.45 | P-1 |
| | (1.89 mmol) | MeOH | | | | | | | |
| | H₂(BDC) | | | | | | | | |
| | (1.93 mmol) | | | | | | | | |
| MOF-4 | Zn(NO₃)₂•6H₂O | ethanol | 90 | 90 | 90 | 14.728 | 14.728 | 14.728 | P2(1)3 |
| | (1.00 mmol) | | | | | | | | |
| | H₃(BTC) | | | | | | | | |
| | (0.5 mmol) | | | | | | | | |
| MOF-5 | Zn(NO₃)₂•6H₂O | DMF | 90 | 90 | 90 | 25.669 | 25.669 | 25.669 | Fm-3m |
| | (2.22 mmol) | chloro- | | | | | | | |
| | H₂(BDC) | benzene | | | | | | | |
| | (2.17 mmol) | | | | | | | | |
| MOF-38 | Zn(NO₃)₂•6H₂O | DMF | 90 | 90 | 90 | 20.657 | 20.657 | 17.84 | I4cm |
| | (0.27 mmol) | chloro- | | | | | | | |
| | H₃(BTC) | benzene | | | | | | | |
| | (0.15 mmol) | | | | | | | | |
| MOF-31 | Zn(NO₃)₂•6H₂O | ethanol | 90 | 90 | 90 | 10.821 | 10.821 | 10.821 | Pn(-3)m |
| Zn(ADC)₂ | 0.4 mmol | | | | | | | | |
| | H₂(ADC) | | | | | | | | |
| | 0.8 mmol | | | | | | | | |
| MOF-12 | Zn(NO₃)₂•6H₂O | ethanol | 90 | 90 | 90 | 15.745 | 16.907 | 18.167 | Pbca |
| Zn₂(ATC) | 0.3 mmol | | | | | | | | |
| | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.2 mmol | chloro- | | | | | | | |
| | H₂NDC | benzene | | | | | | | |
| | 0.2 mmol | | | | | | | | |
| MOF-8 | Tb(NO₃)₃•5H₂O | DMSO | 90 | 115.7 | 90 | 19.83 | 9.822 | 19.183 | C2/c |
| Tb₂ (ADC) | 0.10 mmol | MeOH | | | | | | | |
| | H₂ADC | | | | | | | | |
| | 0.20 mmol | | | | | | | | |
| MOF-9 | Tb(NO₃)₃•5H₂O | DMSO | 90 | 102.09 | 90 | 27.056 | 16.795 | 28.139 | C2/c |
| Tb₂ (ADC) | 0.08 mmol | | | | | | | | |
| | H₂ADB | | | | | | | | |
| | 0.12 mmol | | | | | | | | |
| MOF-6 | Tb(NO₃)₃•5H₂O | DMF | 90 | 91.28 | 90 | 17.599 | 19.996 | 10.545 | P21/c |
| | 0.30 mmol | MeOH | | | | | | | |
| | H₂ (BDC) | | | | | | | | |
| | 0.30 mmol | | | | | | | | |
| MOF-7 | Tb(NO₃)₃•5H₂O | H₂O | 102.3 | 91.12 | 101.5 | 6.142 | 10.069 | 10.096 | P-1 |
| | 0.15 mmol | | | | | | | | |
| | H₂(BDC) | | | | | | | | |
| | 0.15 mmol | | | | | | | | |
| MOF-69A | Zn(NO₃)₂•6H₂O | DEF | 90 | 111.6 | 90 | 23.12 | 20.92 | 12 | C2/c |
| | 0.083 mmol | H₂O₂ | | | | | | | |
| | 4,4′BPDC | MeNH₂ | | | | | | | |
| | 0.041 mmol | | | | | | | | |
| MOF-69B | Zn(NO₃)₂•6H₂O | DEF | 90 | 95.3 | 90 | 20.17 | 18.55 | 12.16 | C2/c |
| | 0.083 mmol | H₂O₂ | | | | | | | |
| | 2,6-NCD | MeNH₂ | | | | | | | |
| | 0.041 mmol | | | | | | | | |
| MOF-11 | Cu(NO₃)₂•2.5H₂O | H₂O | 90 | 93.86 | 90 | 12.987 | 11.22 | 11.336 | C2/c |
| Cu₂(ATC) | 0.47 mmol | | | | | | | | |
| | H₂ATC | | | | | | | | |
| | 0.22 mmol | | | | | | | | |
| MOF-11 | | | 90 | 90 | 90 | 8.4671 | 8.4671 | 14.44 | P42/ |
| CU₂(ATC) | | | | | | | | | mmc |
| dehydr. | | | | | | | | | |
| MOF-14 | Cu(NO₃)₂•2.5H₂O | H₂O | 90 | 90 | 90 | 26.946 | 26.946 | 26.946 | Im-3 |
| Cu₃ (BTB) | 0.28 mmol | DMF | | | | | | | |
| | H₃BTB | EtOH | | | | | | | |
| | 0.052 mmol | | | | | | | | |
| MOF-32 | Cd(NO₃)₂•4H₂O | H₂O | 90 | 90 | 90 | 13.468 | 13.468 | 13.468 | P(-4)3m |
| Cd(ATC) | 0.24 mmol | NaOH | | | | | | | |
| | H₄ATC | | | | | | | | |
| | 0.10 mmol | | | | | | | | |
| MOF-33 | ZnCl₂ | H₂O | 90 | 90 | 90 | 19.561 | 15.255 | 23.404 | Imma |
| Zn₂ (ATB) | 0.15 mmol | DMF | | | | | | | |
| | H₄ATB | EtOH | | | | | | | |
| | 0.02 mmol | | | | | | | | |
| MOF-34 | Ni(NO₃)₂•6H₂O | H₂O | 90 | 90 | 90 | 10.066 | 11.163 | 19.201 | P2₁2₁2₁ |
| Ni(ATC) | 0.24 mmol | NaOH | | | | | | | |
| | H₄ATC | | | | | | | | |
| | 0.10 mmol | | | | | | | | |
| MOF-36 | Zn(NO₃)₂•4H₂O | H₂O | 90 | 90 | 90 | 15.745 | 16.907 | 18.167 | Pbca |
| Zn₂ (MTB) | 0.20 mmol | DMF | | | | | | | |
| | H₄MTB | | | | | | | | |
| | 0.04 mmol | | | | | | | | |
| MOF-39 | Zn(NO₃)₂ 4H₂O | H₂O | 90 | 90 | 90 | 17.158 | 21.591 | 25.308 | Pnma |
| Zn₃O(HBTB) | 0.27 mmol | DMF | | | | | | | |
| | H₃BTB | EtOH | | | | | | | |
| | 0.07 mmol | | | | | | | | |
| NO305 | FeCl₂•4H₂O | DMF | 90 | 90 | 120 | 8.2692 | 8.2692 | 63.566 | R-3c |
| | 5.03 mmol | | | | | | | | |
| | formic acid. | | | | | | | | |
| | 86.90 mmol | | | | | | | | |
| NO306A | FeCl₂•4H₂O | DEF | 90 | 90 | 90 | 9.9364 | 18.374 | 18.374 | Pbcn |
| | 5.03 mmol | | | | | | | | |
| | formic acid. | | | | | | | | |
| | 86.90 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| BPR48 | Zn(NO₃)₂ 6H₂O | DMSO | 90 | 90 | 90 | 14.5 | 17.04 | 18.02 | Pbca |
| A2 | 0.012 mmol | toluene | | | | | | | |
| | H₂BDC | | | | | | | | |
| | 0.012 mmol | | | | | | | | |
| BPR69 | Cd(NO₃)₂ 4H₂O | DMSO | 90 | 98.76 | 90 | 14.16 | 15.72 | 17.66 | Cc |
| B1 | 0.0212 mmol | | | | | | | | |
| | H₂BDC | | | | | | | | |
| | 0.0428 mmol | | | | | | | | |
| BPR92 | Co(NO₃)₂•6H₂O | NMP | 106.3 | 107.63 | 107.2 | 7.5308 | 10.942 | 11.025 | P1 |
| A2 | 0.018 mmol | | | | | | | | |
| | H₂BDC | | | | | | | | |
| | 0.018 mmol | | | | | | | | |
| BPR95 | Cd(NO₃)₂ 4H₂O | NMP | 90 | 112.8 | 90 | 14.460 | 11.085 | 15.829 | P2(1)/n |
| C5 | 0.012 mmol | | | | | | | | |
| | H₂BDC | | | | | | | | |
| | 0.36 mmol | | | | | | | | |
| Cu C₆H₄O₆ | Cu(NO₃)₂•2.5H₂O | DMF | 90 | 105.29 | 90 | 15.259 | 14.816 | 14.13 | P2(1)/c |
| | 0.370 mmol | chloro- | | | | | | | |
| | H₂BDC(OH)₂ | benzene | | | | | | | |
| | 0.37 mmol | | | | | | | | |
| M(BTC) | Co(SO₄) H₂O | DMF | as for MOF-0 | | | | | | |
| MOF-0 | 0.055 mmol | | | | | | | | |
| similar | H₃BTC | | | | | | | | |
| | 0.037 mmol | | | | | | | | |
| Tb(C₆H₄O₆) | Tb(NO₃)₃•5H₂O | DMF | 104.6 | 107.9 | 97.147 | 10.491 | 10.981 | 12.541 | P-1 |
| | 0.370 mmol | chloro- | | | | | | | |
| | H₂(C₆H₄O₆) | benzene | | | | | | | |
| | 0.56 mmol | | | | | | | | |
| Zn (C₂O₄) | ZnCl₂ | DMF | 90 | 120 | 90 | 9.4168 | 9.4168 | 8.464 | P(-3)1m |
| | 0.370 mmol | chloro- | | | | | | | |
| | oxalic acid | benzene | | | | | | | |
| | 0.37 mmol | | | | | | | | |
| Co(CHO) | Co(NO₃)₂•5H₂O | DMF | 90 | 91.32 | 90 | 11.328 | 10.049 | 14.854 | P2(1)/n |
| | 0.043 mmol | | | | | | | | |
| | formic acid | | | | | | | | |
| | 1.60 mmol | | | | | | | | |
| Cd(CHO) | Cd(NO₃)₂•4H₂O | DMF | 90 | 120 | 90 | 8.5168 | 8.5168 | 22.674 | R-3c |
| | 0.185 mmol | | | | | | | | |
| | formic acid | | | | | | | | |
| | 0.185 mmol | | | | | | | | |
| Cu(C₃H₂O₄) | Cu(NO₃)₂•2.5H₂O | DMF | 90 | 90 | 90 | 8.366 | 8.366 | 11.919 | P43 |
| | 0.043 mmol | | | | | | | | |
| | malonic acid | | | | | | | | |
| | 0.192 mmol | | | | | | | | |
| Zn₆ (NDC)₅ | Zn(NO₃)₂•6H₂O | DMF | 90 | 95.902 | 90 | 19.504 | 16.482 | 14.64 | C2/m |
| MOF-48 | 0.097 mmol | chloro- | | | | | | | |
| | 14 NDC | benzene | | | | | | | |
| | 0.069 mmol | H₂O₂ | | | | | | | |
| MOF-47 | Zn(NO₃)₂ 6H₂O | DMF | 90 | 92.55 | 90 | 11.303 | 16.029 | 17.535 | P2(1)/c |
| | 0.185 mmol | chloro- | | | | | | | |
| | H₂(BDC[CH₃]₄) | benzene | | | | | | | |
| | 0.185 mmol | H₂O₂ | | | | | | | |
| MO25 | Cu(NO₃)₂•2.5H₂O | DMF | 90 | 112.0 | 90 | 23.880 | 16.834 | 18.389 | P2(1)/c |
| | 0.084 mmol | | | | | | | | |
| | BPhDC | | | | | | | | |
| | 0.085 mmol | | | | | | | | |
| Cu-thio | Cu(NO₃)₂•2.5H₂O | DEF | 90 | 113.6 | 90 | 15.4747 | 14.514 | 14.032 | P2(1)/c |
| | 0.084 mmol | | | | | | | | |
| | thiophene- | | | | | | | | |
| | dicarboxylic acid | | | | | | | | |
| | 0.085 mmol | | | | | | | | |
| ClBDC1 | Cu(NO₃)₂•2.5H₂O | DMF | 90 | 105.6 | 90 | 14.911 | 15.622 | 18.413 | C2/c |
| | 0.084 mmol | | | | | | | | |
| | H₂(BDCCl₂) | | | | | | | | |
| | 0.085 mmol | | | | | | | | |
| MOF-101 | Cu(NO₃)₂•2.5H₂O | DMF | 90 | 90 | 90 | 21.607 | 20.607 | 20.073 | Fm3m |
| | 0.084 mmol | | | | | | | | |
| | BrBDC | | | | | | | | |
| | 0.085 mmol | | | | | | | | |
| Zn₃(BTC)₂ | ZnCl₂ | DMF | 90 | 90 | 90 | 26.572 | 26.572 | 26.572 | Fm-3m |
| | 0.033 mmol | EtOH | | | | | | | |
| | H₃BTC | base | | | | | | | |
| | 0.033 mmol | added | | | | | | | |
| MOF-j | Co(CH₃CO₂)₂•4H₂O | H₂O | 90 | 112.0 | 90 | 17.482 | 12.963 | 6.559 | C2 |
| | (1.65 mmol) | | | | | | | | |
| | H₃(BZC) | | | | | | | | |
| | (0.95 mmol) | | | | | | | | |
| MOF-n | Zn(NO₃)₂•6H₂O | ethanol | 90 | 90 | 120 | 16.711 | 16.711 | 14.189 | P6(3)/mcm |
| | H₃ (BTC) | | | | | | | | |
| PbBDC | Pb(NO₃)₂ | DMF | 90 | 102.7 | 90 | 8.3639 | 17.991 | 9.9617 | P2(1)/n |
| | (0.181 mmol) | ethanol | | | | | | | |
| | H₂(BDC) | | | | | | | | |
| | (0.181 mmol) | | | | | | | | |
| Znhex | Zn(NO₃)₂•6H₂O | DMF | 90 | 90 | 120 | 37.1165 | 37.117 | 30.019 | P3(1)c |
| | (0.171 mmol) | p-xylene | | | | | | | |
| | H₃BTB | ethanol | | | | | | | |
| | (0.114 mmol) | | | | | | | | |
| AS16 | FeBr₂ | DMF | 90 | 90.13 | 90 | 7.2595 | 8.7894 | 19.484 | P2(1)c |
| | 0.927 mmol | anhydr. | | | | | | | |
| | H₂(BDC) | | | | | | | | |
| | 0.927 mmol | | | | | | | | |
| AS27-2 | FeBr₂ | DMF | 90 | 90 | 90 | 26.735 | 26.735 | 26.735 | Fm3m |
| | 0.927 mmol | anhydr. | | | | | | | |
| | H₃(BDC) | | | | | | | | |
| | 0.464 mmol | | | | | | | | |
| AS32 | FeCl₃ | DMF | 90 | 90 | 120 | 12.535 | 12.535 | 18.479 | P6(2)c |
| | 1.23 mmol | anhydr. | | | | | | | |
| | H₂(BDC) | ethanol | | | | | | | |
| | 1.23 mmol | | | | | | | | |
| AS54-3 | FeBr₂ | DMF | 90 | 109.98 | 90 | 12.019 | 15.286 | 14.399 | C2 |
| | 0.927 | anhydr. | | | | | | | |
| | BPDC | n-propanol | | | | | | | |
| | 0.927 mmol | | | | | | | | |
| AS61-4 | FeBr₂ | pyridine | 90 | 90 | 120 | 13.017 | 13.017 | 14.896 | P6(2)c |
| | 0.927 mmol | anhydr. | | | | | | | |
| | m-BDC | | | | | | | | |
| | 0.927 mmol | | | | | | | | |
| AS68-7 | FeBr₂ | DMF | 90 | 90 | 90 | 18.3407 | 10.036 | 18.039 | Pca2₁ |
| | 0.927 mmol | anhydr. | | | | | | | |
| | m-BDC | pyridine | | | | | | | |
| | 1.204 mmol | | | | | | | | |
| Zn(ADC) | Zn(NO₃)₂•6H₂O | DMF | 90 | 99.85 | 90 | 16.764 | 9.349 | 9.635 | C2/c |
| | 0.37 mmol | chloro- | | | | | | | |
| | H₂(ADC) | benzene | | | | | | | |
| | 0.36 mmol | | | | | | | | |
| MOF-12 | Zn(NO₃)₂•6H₂O | ethanol | 90 | 90 | 90 | 15.745 | 16.907 | 18.167 | Pbca |
| Zn₂ (ATC) | 0.30 mmol | | | | | | | | |
| | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.20 mmol | chloro- | | | | | | | |
| | H₂NDC | benzene | | | | | | | |
| | 0.20 mmol | | | | | | | | |
| Zn(NDC) | Zn(NO₃)₂•6H₂O | DMSO | 68.08 | 75.33 | 88.31 | 8.631 | 10.207 | 13.114 | P-1 |
| (DMSO) | H₂NDC | | | | | | | | |
| Zn(NDC) | Zn(NO₃)₂•6H₂O | | 90 | 99.2 | 90 | 19.289 | 17.628 | 15.052 | C2/c |
| | H₂NDC | | | | | | | | |
| Zn(HPDC) | Zn(NO₃)₂•4H₂O | DMF | 107.9 | 105.06 | 94.4 | 8.326 | 12.085 | 13.767 | P-1 |
| | 0.23 mmol | H₂O | | | | | | | |
| | H₂(HPDC) | | | | | | | | |
| | 0.05 mmol | | | | | | | | |
| Co(HPDC) | Co(NO₃)₂•6H₂O | DMF | 90 | 97.69 | 90 | 29.677 | 9.63 | 7.981 | C2/c |
| | 0.21 mmol | H₂O/ | | | | | | | |
| | H₂ (HPDC) | ethanol | | | | | | | |
| | 0.06 mmol | | | | | | | | |
| Zn₃(PDC) | Zn(NO₃)₂•4H₂O | DMF/ | 79.34 | 80.8 | 85.83 | 8.564 | 14.046 | 26.428 | P-1 |
| 2.5 | 0.17 mmol | ClBz | | | | | | | |
| | H₂(HPDC) | H₂0/TEA | | | | | | | |
| | 0.05 mmol | | | | | | | | |
| Cd₂ | Cd(NO₃)₂•4H₂O | methanol/ | 70.59 | 72.75 | 87.14 | 10.102 | 14.412 | 14.964 | P-1 |
| (TPDC)2 | 0.06 mmol | CHP | | | | | | | |
| | H₂(HPDC) | H₂O | | | | | | | |
| | 0.06 mmol | | | | | | | | |
| Tb(PDC)1.5 | Tb(NO₃)₃•5H₂O | DMF | 109.8 | 103.61 | 100.14 | 9.829 | 12.11 | 14.628 | P-1 |
| | 0.21 mmol | H₂O/ | | | | | | | |
| | H₂(PDC) | ethanol | | | | | | | |
| | 0.034 mmol | | | | | | | | |
| ZnDBP | Zn(NO₃)₂•6H₂O | MeOH | 90 | 93.67 | 90 | 9.254 | 10.762 | 27.93 | P2/n |
| | 0.05 mmol | | | | | | | | |
| | dibenzyl | | | | | | | | |
| | phosphate | | | | | | | | |
| | 0.10 mmol | | | | | | | | |
| Zn₃(BPDC) | ZnBr₂ | DMF | 90 | 102.76 | 90 | 11.49 | 14.79 | 19.18 | P21/n |
| | 0.021 mmol | | | | | | | | |
| | 4,4′BPDC | | | | | | | | |
| | 0.005 mmol | | | | | | | | |
| CdBDC | Cd(NO₃)₂•4H₂O | DMF | 90 | 95.85 | 90 | 11.2 | 11.11 | 16.71 | P21/n |
| | 0.100 mmol | Na₂SiO₃ | | | | | | | |
| | H₂(BDC) | (aq) | | | | | | | |
| | 0.401 mmol | | | | | | | | |
| Cd-mBDC | Cd(NO₃)₂•4H₂O | DMF | 90 | 101.1 | 90 | 13.69 | 18.25 | 14.91 | C2/c |
| | 0.009 mmol | MeNH₂ | | | | | | | |
| | H₂(mBDC) | | | | | | | | |
| | 0.018 mmol | | | | | | | | |
| Zn₄OBNDC | Zn(NO₃)₂•6H₂O | DEF | 90 | 90 | 90 | 22.35 | 26.05 | 59.56 | Fmmm |
| | 0.041 mmol | MeNH₂ | | | | | | | |
| | BNDC | H₂O₂ | | | | | | | |
| Eu(TCA) | Eu(NO₃)₃•6H₂O | DMF | 90 | 90 | 90 | 23.325 | 23.325 | 23.325 | Pm-3n |
| | 0.14 mmol | chloro- | | | | | | | |
| | TCA | benzene | | | | | | | |
| | 0.026 mmol | | | | | | | | |
| Tb(TCA) | Tb(NO₃)₃•6H₂O | DMF | 90 | 90 | 90 | 23.272 | 23.272 | 23.372 | Pm-3n |
| | 0.069 mmol | chloro- | | | | | | | |
| | TCA | benzene | | | | | | | |
| | 0.026 mmol | | | | | | | | |
| Formate | Ce(NO₃)₃•6H₂O | H₂O | 90 | 90 | 120 | 10.668 | 10.667 | 4.107 | R-3m |
| | 0.138 mmol | ethanol | | | | | | | |
| | formic acid | | | | | | | | |
| | 0.43 mmol | | | | | | | | |
| | FeCl₂•4H₂O | DMF | 90 | 90 | 120 | 8.2692 | 8.2692 | 63.566 | R-3c |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 9.9364 | 18.374 | 18.374 | Pbcn |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 8.335 | 8.335 | 13.34 | P-31c |
| | 5.03 mmol | | | | | | | | |
| | formic acid | | | | | | | | |
| | 86.90 mmol | | | | | | | | |
| NO330 | FeCl₂•4H₂O | formamide | 90 | 90 | 90 | 8.7749 | 11.655 | 8.3297 | Pnna |
| | 0.50 mmol | | | | | | | | |
| | formic acid | | | | | | | | |
| | 8.69 mmol | | | | | | | | |
| NO332 | FeCl₂•4H₂O | DIP | 90 | 90 | 90 | 10.0313 | 18.808 | 18.355 | Pbcn |
| | 0.50 mmol | | | | | | | | |
| | formic acid | | | | | | | | |
| | 8.69 mmol | | | | | | | | |
| NO333 | FeCl₂•4H₂O | DBF | 90 | 90 | 90 | 45.2754 | 23.861 | 12.441 | Cmcm |
| | 0.50 mmol | | | | | | | | |
| | formic acid | | | | | | | | |
| | 8.69 mmol | | | | | | | | |
| NO335 | FeCl₂•4H₂O | CHF | 90 | 91.372 | 90 | 11.5964 | 10.187 | 14.945 | P21/n |
| | 0.50 mmol | | | | | | | | |
| | formic acid | | | | | | | | |
| | 8.69 mmol | | | | | | | | |
| NO336 | FeCl₂•4H₂O | MFA | 90 | 90 | 90 | 11.7945 | 48.843 | 8.4136 | Pbcm |
| | 0.50 mmol | | | | | | | | |
| | formic acid | | | | | | | | |
| | 8.69 mmol | | | | | | | | |
| NO13 | Mn(Ac)₂•4H₂O | ethanol | 90 | 90 | 90 | 18.66 | 11.762 | 9.418 | Pbcn |
| | 0.46 mmol | | | | | | | | |
| | benzoic acid | | | | | | | | |
| | 0.92 mmol | | | | | | | | |
| | bipyridine | | | | | | | | |
| | 0.46 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| Mn(hfac)₂ | Mn(Ac)₂•4H₂O | ether | 90 | 95.32 | 90 | 9.572 | 17.162 | 14.041 | C2/c |
| (O₂CC₆H₅) | 0.46 mmol | | | | | | | | |
| | Hfac | | | | | | | | |
| | 0.92 mmol | | | | | | | | |
| | bipyridine | | | | | | | | |
| | 0.46 mmol | | | | | | | | |
| BPR43G2 | Zn(NO₃)₂•6H₂O | DMF | 90 | 91.37 | 90 | 17.96 | 6.38 | 7.19 | C2/c |
| | 0.0288 mmol | CH₃CN | | | | | | | |
| | H₂BDC | | | | | | | | |
| | 0.0072 mmol | | | | | | | | |
| BPR48A2 | Zn(NO₃)₂ 6H₂O | DMSO | 90 | 90 | 90 | 14.5 | 17.04 | 18.02 | Pbca |
| | 0.012 mmol | toluene | | | | | | | |
| | H₂BDC | | | | | | | | |
| | 0.012 mmol | | | | | | | | |
| BPR49B1 | Zn(NO₃)₂ 6H₂O | DMSO | 90 | 91.172 | 90 | 33.181 | 9.824 | 17.884 | C2/c |
| | 0.024 mmol | methanol | | | | | | | |
| | H₂BDC | | | | | | | | |
| | 0.048 mmol | | | | | | | | |
| BPR56E1 | Zn(NO₃)₂ 6H₂O | DMSO | 90 | 90.096 | 90 | 14.5873 | 14.153 | 17.183 | P2(1)/n |
| | 0.012 mmol | n-propanol | | | | | | | |
| | H₂BDC | | | | | | | | |
| | 0.024 mmol | | | | | | | | |
| BPR68D10 | Zn(NO₃)₂ 6H₂O | DMSO | 90 | 95.316 | 90 | 10.0627 | 10.17 | 16.413 | P2(1)/c |
| | 0.0016 mmol | benzene | | | | | | | |
| | H₃BTC | | | | | | | | |
| | 0.0064 mmol | | | | | | | | |
| BPR69B1 | Cd(NO₃)₂ 4H₂O | DMSO | 90 | 98.76 | 90 | 14.16 | 15.72 | 17.66 | Cc |
| | 0.0212 mmol | | | | | | | | |
| | H₂BDC | | | | | | | | |
| | 0.0428 mmol | | | | | | | | |
| BPR73E4 | Cd(NO₃)₂ 4H₂O | DMSO | 90 | 92.324 | 90 | 8.7231 | 7.0568 | 18.438 | P2(1)/n |
| | 0.006 mmol | toluene | | | | | | | |
| | H₂BDC | | | | | | | | |
| | 0.003 mmol | | | | | | | | |
| BPR76D5 | Zn(NO₃)₂6H₂O | DMSO | 90 | 104.17 | 90 | 14.4191 | 6.2599 | 7.0611 | Pc |
| | 0.0009 mmol | | | | | | | | |
| | H₂BzPDC | | | | | | | | |
| | 0.0036 mmol | | | | | | | | |
| BPR80B5 | Cd(NO₃)₂•4H₂O | DMF | 90 | 115.11 | 90 | 28.049 | 9.184 | 17.837 | C2/c |
| | 0.018 mmol | | | | | | | | |
| | H₂BDC | | | | | | | | |
| | 0.036 mmol | | | | | | | | |
| BPR80H5 | Cd(NO₃)₂ 4H₂O | DMF | 90 | 119.06 | 90 | 11.4746 | 6.2151 | 17.268 | P2/c |
| | 0.027 mmol | | | | | | | | |
| | H₂BDC | | | | | | | | |
| | 0.027 mmol | | | | | | | | |
| BPR82C6 | Cd(NO₃)₂ 4H₂O | DMF | 90 | 90 | 90 | 9.7721 | 21.142 | 27.77 | Fdd2 |
| | 0.0068 mmol | | | | | | | | |
| | H₂BDC | | | | | | | | |
| | 0.202 mmol | | | | | | | | |
| BPR86C3 | Co(NO₃)₂ 6H₂O | DMF | 90 | 90 | 90 | 18.3449 | 10.031 | 17.983 | Pca2(1) |
| | 0.0025 mmol | | | | | | | | |
| | H₂BDC | | | | | | | | |
| | 0.075 mmol | | | | | | | | |
| BPR86H6 | Cd(NO₃)₂•6H₂O | DMF | 80.98 | 89.69 | 83.412 | 9.8752 | 10.263 | 15.362 | P-1 |
| | 0.010 mmol | | | | | | | | |
| | H₂BDC | | | | | | | | |
| | 0.010 mmol | | | | | | | | |
| | Co(NO₃)₂ 6H₂O | NMP | 106.3 | 107.63 | 107.2 | 7.5308 | 10.942 | 11.025 | P1 |
| BPR95A2 | Zn(NO₃)₂ 6H₂O | NMP | 90 | 102.9 | 90 | 7.4502 | 13.767 | 12.713 | P2(1)/c |
| | 0.012 mmol | | | | | | | | |
| | H₂BDC | | | | | | | | |
| | 0.012 mmol | | | | | | | | |
| CuC₆F₄O₄ | Cu(NO₃)₂•2.5H₂O | DMF | 90 | 98.834 | 90 | 10.9675 | 24.43 | 22.553 | P2(1)/n |
| | 0.370 mmol | chloro- | | | | | | | |
| | H₂BDC(OH)₂ | benzene | | | | | | | |
| | 0.37 mmol | | | | | | | | |
| Fe formic | FeCl₂•4H₂O | DMF | 90 | 91.543 | 90 | 11.495 | 9.963 | 14.48 | P2(1)/n |
| | 0.370 mmol | | | | | | | | |
| | formic acid | | | | | | | | |
| | 0.37 mmol | | | | | | | | |
| Mg formic | Mg(NO₃)₂•6H₂O | DMF | 90 | 91.359 | 90 | 11.383 | 9.932 | 14.656 | P2(1)/n |
| | 0.370 mmol | | | | | | | | |
| | formic acid | | | | | | | | |
| | 0.37 mmol | | | | | | | | |
| MgC₆H₄O₆ | Mg(NO₃)₂•6H₂O | DMF | 90 | 96.624 | 90 | 17.245 | 9.943 | 9.273 | C2/c |
| | 0.370 mmol | | | | | | | | |
| | H₂BDC(OH)₂ | | | | | | | | |
| | 0.37 mmol | | | | | | | | |
| Zn | ZnCl₂ | DMF | 90 | 94.714 | 90 | 7.3386 | 16.834 | 12.52 | P2(1)/n |
| C₂H₄BDC | 0.44 mmol | | | | | | | | |
| MOF-38 | CBBDC | | | | | | | | |
| | 0.261 mmol | | | | | | | | |
| MOF-49 | ZnCl₂ | DMF | 90 | 93.459 | 90 | 13.509 | 11.984 | 27.039 | P2/c |
| | 0.44 mmol | CH₃CN | | | | | | | |
| | m-BDC | | | | | | | | |
| | 0.261 mmol | | | | | | | | |
| MOF-26 | Cu(NO₃)₂•5H₂O | DMF | 90 | 95.607 | 90 | 20.8797 | 16.017 | 26.176 | P2(1)/n |
| | 0.084 mmol | | | | | | | | |
| | DCPE | | | | | | | | |
| | 0.085 mmol | | | | | | | | |
| MOF-112 | Cu(NO₃)₂•2.5H₂O | DMF | 90 | 107.49 | 90 | 29.3241 | 21.297 | 18.069 | C2/c |
| | 0.084 mmol | ethanol | | | | | | | |
| | o-Br-m-BDC | | | | | | | | |
| | 0.085 mmol | | | | | | | | |
| MOF-109 | Cu(NO₃)₂•2.5H₂O | DMF | 90 | 111.98 | 90 | 23.8801 | 16.834 | 18.389 | P2(1)/c |
| | 0.084 mmol | | | | | | | | |
| | KDB | | | | | | | | |
| | 0.085 mmol | | | | | | | | |
| MOF-111 | Cu(NO₃)₂•2.5H₂O | DMF | 90 | 102.16 | 90 | 10.6767 | 18.781 | 21.052 | C2/c |
| | 0.084 mmol | ethanol | | | | | | | |
| | o-BrBDC | | | | | | | | |
| | 0.085 mmol | | | | | | | | |
| MOF-110 | Cu(NO₃)₂•2.5H₂O | DMF | 90 | 90 | 120 | 20.0652 | 20.065 | 20.747 | R-3/m |
| | 0.084 mmol | | | | | | | | |
| | thiophene- | | | | | | | | |
| | dicarboxylic acid | | | | | | | | |
| | 0.085 mmol | | | | | | | | |
| MOF-107 | Cu(NO₃)₂•2.5H₂O | DEF | 104.8 | 97.075 | 95.206 | 11.032 | 18.067 | 18.452 | P-1 |
| | 0.084 mmol | | | | | | | | |
| | thiophene- | | | | | | | | |
| | dicarboxylic acid | | | | | | | | |
| | 0.085 mmol | | | | | | | | |
| MOF-108 | Cu(NO₃)₂•2.5H₂O | DBF/ | 90 | 113.63 | 90 | 15.4747 | 14.514 | 14.032 | C2/c |
| | 0.084 mmol | methanol | | | | | | | |
| | thiophene- | | | | | | | | |
| | dicarboxylic acid | | | | | | | | |
| | 0.085 mmol | | | | | | | | |
| MOF-102 | Cu(NO₃)₂•2.5H₂O | DMF | 91.63 | 106.24 | 112.01 | 9.3845 | 10.794 | 10.831 | P-1 |
| | 0.084 mmol | | | | | | | | |
| | H₂(BDCCl₂) | | | | | | | | |
| | 0.085 mmol | | | | | | | | |
| Clbdc1 | Cu(NO₃)₂•2.5H₂O | DEF | 90 | 105.56 | 90 | 14.911 | 15.622 | 18.413 | P-1 |
| | 0.084 mmol | | | | | | | | |
| | H₂(BDCCl₂) | | | | | | | | |
| | 0.085 mmol | | | | | | | | |
| Cu(NMOP) | Cu(NO₃)₂•2.5H₂O | DMF | 90 | 102.37 | 90 | 14.9238 | 18.727 | 15.529 | P2(1)/m |
| | 0.084 mmol | | | | | | | | |
| | NBDC | | | | | | | | |
| | 0.085 mmol | | | | | | | | |
| Tb(BTC) | Tb(NO₃)₃•5H₂O | DMF | 90 | 106.02 | 90 | 18.6986 | 11.368 | 19.721 | |
| | 0.033 mmol | | | | | | | | |
| | H₃BTC | | | | | | | | |
| | 0.033 mmol | | | | | | | | |
| Zn₃(BTC)₂ | ZnCl₂ | DMF | 90 | 90 | 90 | 26.572 | 26.572 | 26.572 | Fm-3m |
| Honk | 0.033 mmol | ethanol | | | | | | | |
| | H₃BTC | | | | | | | | |
| | 0.033 mmol | | | | | | | | |
| Zn₄O(NDC) | Zn(NO₃)₂•4H₂O | DMF | 90 | 90 | 90 | 41.5594 | 18.818 | 17.574 | aba2 |
| | 0.066 mmol | ethanol | | | | | | | |
| | 14NDC | | | | | | | | |
| | 0.066 mmol | | | | | | | | |
| CdTDC | Cd(NO₃)₂•4H₂O | DMF | 90 | 90 | 90 | 12.173 | 10.485 | 7.33 | Pmma |
| | 0.014 mmol | H₂O | | | | | | | |
| | thiophene | | | | | | | | |
| | 0.040 mmol | | | | | | | | |
| | DABCO | | | | | | | | |
| | 0.020 mmol | | | | | | | | |
| IRMOF-2 | Zn(NO₃)₂•4H₂O | DEF | 90 | 90 | 90 | 25.772 | 25.772 | 25.772 | Fm-3m |
| | 0.160 mmol | | | | | | | | |
| | o-Br-BDC | | | | | | | | |
| | 0.60 mmol | | | | | | | | |
| IRMOF-3 | Zn(NO₃)₂•4H₂O | DEF | 90 | 90 | 90 | 25.747 | 25.747 | 25.747 | Fm-3m |
| | 0.20 mmol | ethanol | | | | | | | |
| | H₂N-BDC | | | | | | | | |
| | 0.60 mmol | | | | | | | | |
| IRMOF-4 | Zn(NO₃)₂•4H₂O | DEF | 90 | 90 | 90 | 25.849 | 25.849 | 25.849 | Fm-3m |
| | 0.11 mmol | | | | | | | | |
| | [C₃H₇O]₂-BDC | | | | | | | | |
| | 0.48 mmol | | | | | | | | |
| IRMOF-5 | Zn(NO₃)₂•4H₂O | DEF | 90 | 90 | 90 | 12.882 | 12.882 | 12.882 | Pm-3m |
| | 0.13 mmol | | | | | | | | |
| | [C₅H₁₁O]₂-BDC | | | | | | | | |
| | 0.50 mmol | | | | | | | | |
| IRMOF-6 | Zn(NO₃)₂•4H₂O | DEF | 90 | 90 | 90 | 25.842 | 25.842 | 25.842 | Fm-3m |
| | 0.20 mmol | | | | | | | | |
| | [C₂H₄]-BDC | | | | | | | | |
| | 0.60 mmol | | | | | | | | |
| IRMOF-7 | Zn(NO₃)₂•4H₂O | DEF | 90 | 90 | 90 | 12.914 | 12.914 | 12.914 | Pm-3m |
| | 0.07 mmol | | | | | | | | |
| | 1,4NDC | | | | | | | | |
| | 0.20 mmol | | | | | | | | |
| IRMOF-8 | Zn(NO₃)₂•4H₂O | DEF | 90 | 90 | 90 | 30.092 | 30.092 | 30.092 | Fm-3m |
| | 0.55 mmol | | | | | | | | |
| | 2,6NDC | | | | | | | | |
| | 0.42 mmol | | | | | | | | |
| IRMOF-9 | Zn(NO₃)₂•4H₂O | DEF | 90 | 90 | 90 | 17.147 | 23.322 | 25.255 | Pnnm |
| | 0.05 mmol | | | | | | | | |
| | BPDC | | | | | | | | |
| | 0.42 mmol | | | | | | | | |
| IRMOF-10 | Zn(NO₃)₂•4H₂O | DEF | 90 | 90 | 90 | 34.281 | 34.281 | 34.281 | Fm-3m |
| | 0.02 mmol | | | | | | | | |
| | BPDC | | | | | | | | |
| | 0.012 mmol | | | | | | | | |
| IRMOF-11 | Zn(NO₃)₂•4H₂O | DEF | 90 | 90 | 90 | 24.822 | 24.822 | 56.734 | R-3m |
| | 0.05 mmol | | | | | | | | |
| | HPDC | | | | | | | | |
| | 0.20 mmol | | | | | | | | |
| IRMOF-12 | Zn(NO₃)₂•4H₂O | DEF | 90 | 90 | 90 | 34.281 | 34.281 | 34.281 | Fm-3m |
| | 0.017 mmol | | | | | | | | |
| | HPDC | | | | | | | | |
| | 0.12 mmol | | | | | | | | |
| IRMOF-13 | Zn(NO₃)₂•4H₂O | DEF | 90 | 90 | 90 | 24.822 | 24.822 | 56.734 | R-3m |
| | 0.048 mmol | | | | | | | | |
| | PDC | | | | | | | | |
| | 0.31 mmol | | | | | | | | |
| IRMOF-14 | Zn(NO₃)₂•4H₂O | DEF | 90 | 90 | 90 | 34.381 | 34.381 | 34.381 | Fm-3m |
| | 0.17 mmol | | | | | | | | |
| | PDC | | | | | | | | |
| | 0.12 mmol | | | | | | | | |
| IRMOF-15 | Zn(NO₃)₂•4H₂O | DEF | 90 | 90 | 90 | 21.459 | 21.459 | 21.459 | Im-3m |
| | 0.063 mmol | | | | | | | | |
| | TPDC | | | | | | | | |
| | 0.025 mmol | | | | | | | | |
| IRMOF-16 | Zn(NO₃)₂•4H₂O | DEF | 90 | 90 | 90 | 21.49 | 21.49 | 21.49 | Pm-3m |
| | 0.0126 mmol | NMP | | | | | | | |
| | TPDC | | | | | | | | |
| | 0.05 mmol | | | | | | | | |

ADC Acetylenedicarboxylic acid
NDC Naphthalenedicarboxylic acid
BDC Benzenedicarboxylic acid
ATC Adamantanetetracarboxylic acid
BTC Benzenetricarboxylic acid
BTB Benzenetribenzoic acid
MTB Methanetetrabenzoic acid
ATB Adamantanetetrabenzoic acid
ADB Adamantanedibenzoic acid

Further metal organic frameworks are MOF-2 to 4, MOF-9, MOF-31 to 36, MOF-39, MOF-69 to 80, MOF103 to 106, MOF-122, MOF-125, MOF-150, MOF-177, MOF-178, MOF-235, MOF-236, MOF-500, MOF-501, MOF-502, MOF-505, IRMOF-1, IRMOF-61, IRMOP-13, IRMOP-51, MIL-17, MIL-45, MIL-47, MIL-53, MIL-59, MIL-60, MIL-61, MIL-63, MIL-68, MIL-79, MIL-80, MIL-83, MIL-85, CPL-1 to 2, SZL-1 which are described in the literature.

Particularly preferred metal organic frameworks are MIL-53, Zn-tBu-isophthalic acid, Al-BDC, MOF-5, IRMOF-8, Cu-BTC, Al-NDC, Al-aminoBDC, Cu-BDC-TEDA, Zn-BDC-TEDA, Al-BTC, Al-NDC, Mg-NDC, Al-fumarate, Zn-2-methylimidazolate, Zn-2-aminoimidazolate, Cu-biphenyldicarboxylate-TEDA, MOF-177, MOF-74. Even greater preference is given to Al-BDC and Al-BTC.

More preferred metal organic frameworks are Al-terephthalate, Al-fumarate, Mn-terephthalate, Mg-NDC, Y-BDC, Y-imidazoledicarboxylate, Al-imidazoledicarboxylate, Cu-BTC and Zn-dihydroxyterephthalate.

Apart from the conventional method of preparing the MOFs, as described, for example, in U.S. Pat. No. 5,648,508, these can also be prepared by an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Regardless, of the method of preparation, the metal organic framework is obtained in pulverulent or crystalline form. This can be used according to the invention as desiccant either alone or together with other desiccants or further materials. Furthermore, the metal organic framework can be converted into a shaped body.

The present invention therefore further provides the use according to the invention of a metal organic framework as shaped body.

Preferred processes here are extrusion or tableting. In the production of shaped bodies, further materials such as binders, lubricants or other additives can be added to the metal organic framework. It is likewise conceivable for mixtures of framework and other desiccants to be produced as shaped bodies or separately form shaped bodies which are then used as mixtures of shaped bodies.

The possible geometries of these shaped bodies are in principle not subject to any restrictions. For example, possible shapes are, inter alia, pellets such as disk-shaped pellets, pills, spheres, granules, extrudates such as rods, honeycombs, grids or hollow bodies.

Component B is preferably present as shaped bodies. Preferred forms are pellets and rod-like extrudates. The shaped bodies preferably have an extension in at least one direction in space in the range from 0.2 mm to 30 mm, more preferably from 0.5 mm to 5 mm, in particular from 1 mm to 3 mm.

The density of the mixture is typically in the range from 0.2 to 0.7 kg/l.

To produce these shaped bodies, it is in principle possible to employ all suitable methods. In particular, the following processes are preferred:
Kneading of the framework either alone or together with at least one binder and/or at least one pasting agent and/or at least one template compound to give a mixture; shaping of the resulting mixture by means of at least one suitable method such as extrusion; optionally washing and/or drying and/or calcination of the extrudate; optionally finishing treatment.
Application of the framework to at least one optionally porous support material. The material obtained can then be processed further by the above-described method to give a shaped body.
Application of the framework to at least one optionally porous substrate.

Kneading and shaping can be carried out by any suitable method, for example as described in Ullmanns Enzyklopädie der Technischen Chemie, 4th edition, volume 2, p. 313 ff. (1972), whose relevant contents are fully incorporated by reference into the present patent application.

For example, the kneading and/or shaping can preferably be carried out by means of a piston press, roller press in the presence or absence of at least one binder, compounding, pelletization, tableting, extrusion, coextrusion, foaming, spinning, coating, granulation, preferably spray granulation, spraying, spray drying or a combination of two or more of these methods.

Very particular preference is given to producing pellets and/or tablets.

The kneading and/or shaping can be carried out at elevated temperatures, for example in the range from room temperature to 300° C., and/or under superatmospheric pressure, for example in the range from atmospheric pressure to a few hundred bar, and/or in a protective gas atmosphere, for example in the presence of at least one noble gas, nitrogen or a mixture of two or more thereof.

The kneading and/or shaping is, in a further embodiment, carried out with addition of at least one binder, with the binder used basically being able to be any chemical compound which ensures the desired viscosity for the kneading and/or shaping of the Composition to be kneaded and/or shaped. Accordingly, binders can, for the purposes of the present invention, be either viscosity-increasing or viscosity-reducing compounds.

Preferred binders are, for example, inter alia aluminum oxide or binders comprising aluminum oxide, as are described, for example, in WO 94/29408, silicon dioxide as described, for example, in EP 0 592 050 A1, mixtures of silicon dioxide and aluminum oxide, as are described, for example, in WO 94/13584, clay minerals as described, for example, in JP 03-037156 A, for example montmorillonite, kaolin, bentonite, hallosite, dickite, nacrite and anauxite, alkoxysilanes as described, for example, in EP 0 102 544 B1, for example tetraalkoxysilanes such as tetramethoxysilane, tetraethoxysilane, tetrapropoxysilane, tetrabutoxysilane, or, for example, trialkoxysilanes such as trimethoxysilane, triethoxysilane, tripropoxysilane, tributoxysilane, alkoxytitanates, for example tetraalkoxytitanates such as tetramethoxytitanate, tetraethoxytitanate, tetrapropoxytitanate, tetrabutoxytitanate, or, for example, trialkoxytitanates such as trimethoxytitanate, triethoxytitanate, tripropoxytitanate, tributoxytitanate, alkoxyzirconates, for example tetraalkoxyzirconates such as tetramethoxyzirconate, tetraethoxyzirconate, tetrapropoxyzirconate, tetrabutoxyzirconate, or, for example, trialkoxyzirconates such as trimethoxyzirconate, triethoxyzirconate, tripropoxyzirconate, tributoxyzirconate, silica sols and/or amphiphilic substances and/or graphites. Particular preference is given to graphite.

As viscosity-increasing compound, it is, for example, also possible to use, if appropriate in addition to the abovementioned compounds, an organic compound and/or a hydrophilic polymer such as cellulose or a cellulose derivative such as methylcellulose and/or a polyacrylate and/or a polymethacrylate and/or a polyvinyl alcohol and/or a polyvinylpyrrolidone and/or a polyisobutene and/or a polytetrahydrofuran.

As pasting agent, it is possible to use, inter alia, preferably water or at least one alcohol such as a monoalcohol having from 1 to 4 carbon atoms, for example methanol, ethanol, n-propanol, isopropanol, 1-butanol, 2-butanol, 2-methyl-1-propanol or 2-methyl-2-propanol or a mixture of water and at least one of the alcohols mentioned or a polyhydric alcohol such as a glycol, preferably a water-miscible polyhydric alcohol, either alone or as a mixture with water and/or at least one of the monohydric alcohols mentioned.

Further additives which can be used for kneading and/or shaping are, inter alia, amines or amine derivatives such as tetraalkylammonium compounds or amino alcohols and carbonate-comprising compounds such as calcium carbonate. Such further additives are described, for instance, in EP 0 389 041 A1, EP 0 200 260 A1 or WO 95/19222.

The order of the additives such as template compound, binder, pasting agent, viscosity-increasing substance during shaping and kneading is in principle not critical.

In a further, preferred embodiment, the shaped body obtained by kneading and/or shaping is subjected to at least one drying step which is generally carried out at a temperature in the range from 25 to 300° C., preferably in the range from 50 to 300° C. and particularly preferably in the range from 100 to 300° C. It is likewise possible to carry out drying under reduced pressure or under a protective gas atmosphere or by spray drying.

In a particularly preferred embodiment, at least one of the compounds added as additives is at least partly removed from the shaped body during this drying process.

The use according to the invention for drying is effected by bringing the organic liquid into contact with the porous metal organic framework. This can be achieved by static or dynamic drying. In static drying, the desiccant is added to the organic liquid and removed again, while in the case of dynamic drying, the organic liquid flows through the desiccant.

To increase the uptake capacity, the porous metal organic framework can itself be subjected to a drying step by heating before use according to the invention. In this step, the porous metal organic framework is activated in the sense of the present invention.

The metal organic frameworks are typically activated by heating them to from about 100° C. to 200° C. This can be accompanied by application of reduced pressure or use of protective gas such as nitrogen. Here, carbon dioxide can be removed in addition to traces of water and the water uptake capacity can be increased as a result.

The porous metal organic framework can likewise be regenerated by heating after it has taken up water.

It is also possible for the degree of water uptake to be indicated by a color change if an appropriate porous metal organic framework is chosen, in particular when coppercomprising metal organic frameworks are used.

The organic liquid can be any organic liquid. It is typically an organic solvent or a mixture of organic solvents which have a particular concentration of water.

The organic liquid is preferably an alcohol, an ether, an ester, a ketone, an amide, an optionally halogenated hydrocarbon, a nitrile, an amine, a sulfur-comprising organic liquid, a nitro compound or a mixture thereof.

Examples of such organic liquids are disinfectants, inorganic or organic solvents, fuels, in particular gasoline or diesel, hydraulic fluids, cooling fluids, brake fluids or oils, in particular machine oil. The organic liquid can also be a halogenated aliphatic or aromatic, cyclic or acyclic hydrocarbon or a mixture thereof. In particular, the liquid can be acetone, acetonitrile, aniline, anisole, benzene, benzonitrile, bromobenzene, butanol, tert-butanol, quinoline, chlorobenzene, chloroform, cyclohexane, diethylene glycol, diethyl ether, dimethylacetamide, dimethylformamide, dimethyl sulfoxide, dioxane, glacial acetic acid, acetic anhydride, ethyl acetate, ethanol, ethylene carbonate, ethylene dichloride, ethylene glycol, ethylene glycol dimethyl ether, formamide, hexane, isopropanol, methanol, methoxypropanol, 3-methyl-1-butanol, methylene chloride, methyl ethyl ketone, N-methylformamide, N-methylpyrrolidone, nitrobenzene, nitromethane, piperidine, propanol, propylene carbonate, pyrridine, hydrogen sulfide, sulfolane, tetrachloroethene, carbon tetrachloride, tetrahydrofuran, toluene, 1,1,1-trichloroethane, trichloroethylene, triethylamine, triethylene glycol or a mixture thereof.

In particular, the organic liquid is toluene, acetonitrile or heptanol.

### EXAMPLE 1

### Preparation of a Cu-BTC Metal Organic Framework

27.8 kg of anhydrous CuSO₄ are suspended together with 12.84 kg of 1,3,5-benzenetricarboxylic acid (BTC) in 330 kg of ethylene glycol and blanketed with N₂. The vessel is brought to 110° C. and the synthesis mixture is maintained at this temperature for 12 hours while stirring. The solution is cooled to 50° C. and filtered on a pressure filter under a blanket N₂. The filtercake is washed with 4×50 l of methanol and blown dry by means of nitrogen for 96 hours.

### EXAMPLE 2

### Drying of Toluene

100 g of toluene are placed in a conical flask and 1 g of water is added. 10 g of the framework obtained as described in Example 1 are predried at 140° C. in a vacuum drying oven for 16 hours and added to the toluene. The suspension is stirred at room temperature by means of a magnetic stirrer for 3 hours. The water content of the organic phase is determined titrimetically by the Karl-Fischer method at the beginning of the experiment (before addition of the metal organic framework) and at the end of the experiment. It is found that the water content of the organic phase has decreased from 0.06 to 0.02% by weight as a result of the drying procedure.

### EXAMPLE 3

### Drying of Acetonitrile

100 g of acetonitrile are placed in a conical flask and 1 g of water is added. 10 g of the framework obtained as described in Example 1 are predried at 140° C. in a vacuum drying oven for 16 hours and added to the acetonitrile. The suspension is stirred at room temperature by means of a magnetic stirrer for 3 hours. The water content of the organic phase is determined titrimetically by the Karl-Fischer method at the beginning of the experiment (before addition of the metal organic framework) and at the end of the experiment. It is found that the water content of the organic phase has decreased from 1.0 to 0.65% by weight as a result of the drying procedure.

### EXAMPLE 4

### Drying of Heptanol

100 g of heptanol are placed in a conical flask and 1 g of water is added. 10 g of the framework obtained as described in Example 1 are predried at 140° C. in a vacuum drying oven for 16 hours and added to the heptanol. The suspension is stirred at room temperature by means of a magnetic stirrer for 3 hours. The water content of the organic phase is determined titrimetically by the Karl-Fischer method at the beginning of the experiment (before addition of the metal organic framework) and at the end of the experiment. It is found that the water content of the organic phase has decreased from 1.0 to 0.51% by weight as a result of the drying procedure.

1-8. (canceled)

9. A method of reducing water content of an organic liquid or removing water content from an organic liquid comprising:
bringing the organic liquid into contact with a porous metal organic framework comprising at least one at least bidentate organic compound coordinated to at least one metal ion as desiccant.

10. The method according to claim 9, wherein the organic liquid is at least one selected from the group consisting of an alcohol, an ether, an ester, a ketone, an amide, an optionally halogenated hydrocarbon, a nitrile, an amine, a sulfur-comprising organic liquid, and a nitro compound.

11. The method according to claim 9, wherein the organic liquid is toluene, acetonitrile, or heptanol.

12. The method according to claim 9, wherein the at least one metal ion is an ion of a metal selected from the group consisting of Zn, Al, Mg, Cu, Mn, Fe, Co, Ni, Ti, Zr, Y, Sc, V, In, Ca, Cr, Mo, W, and a lanthanide.

13. The method according to claim 12, wherein the at least one metal ion is an ion of the metal copper.

14. The method according to claim 9, wherein the at least one at least bidentate organic compound is:
a protonated or at least partially deprotonated form of a dicarboxylic acid, tricarboxylic acid, or tetracarboxylic acid; or
an analog of said di-, tri-, or tetracarboxylic acid, having at least one carboxylic acid replaced by a sulfonic acid, a thiocarboxylic acid in S- or O-acid form, or a dithioic acid;
optionally substituted with at least one substitutent selected from the group consisting of a hydroxy group, an amine, a methoxy group, a methyl group, a methylamine, a dimethylamine, a nitrile, a halide, and a sulfonic acid.

15. The method according to claim 14, wherein the at least one at least bidentate organic compound is 1,3,5-benzenetricarboxylic acid.

16. The method according to claim 9, wherein the metal organic framework is present as shaped bodies.
